(19) United States
(12) Patent Application Publication
(10) Pub. No.: US 2026/0138587 A1
(43) Pub. Date: May 21, 2026

(54) VEHICLE CONTROL DEVICE

(71) Applicant: ISUZU MOTORS LIMITED, Yokohama-shi (JP)

(72) Inventor: Ryo SEKIGUCHI, Fujisawa-shi (JP)

(21) Appl. No.: 19/346,839

(22) Filed: Oct. 1, 2025

(30) Foreign Application Priority Data
Nov. 20, 2024 (JP) 2024-202305

(51) Int. Cl. B60W 20/15; B60W 30/18; B60W 40/076

(52) U.S. Cl. CPC B60W 20/15; B60W 30/18118; B60W 40/076; B60W 2520/10; B60W 2530/10; B60W 2552/15; B60W 2720/10

(57) ABSTRACT

Provided is a vehicle control device that stops a vehicle at a position where the vehicle is to stop, without frequently operating an accelerator pedal on an uphill road. The vehicle control device controls a drive device of the vehicle based on an operation amount of an operation member and includes: an operation amount acquisition section that acquires the operation amount; a gradient acquisition section that acquires a gradient of a road surface on which the vehicle is traveling; and a control section that controls the drive device such that the vehicle stops at a reference stopping distance, in a case where the gradient is uphill and the operation amount becomes zero during traveling by the drive device.

### CROSS REFERENCE TO RELATED APPLICATIONS

This application is entitled to (or claims) the benefit of Japanese Patent Application No.2024-202305 filed on November 20, 2024, the disclosure of which including the specification, drawings and abstract is incorporated herein by reference in its entirety.

### TECHNICAL FIELD

The present disclosure relates to a vehicle control device.

### BACKGROUND ART

When the driver releases the accelerator pedal while the vehicle is traveling, the vehicle coasts and gradually decelerates to a stop. This occurs because the fuel supply is stoppled in a case where the drive device is an engine, or the power supply is stoppled in a case where the drive device is a motor, and the like. In a case where the driver needs to stop the vehicle before the stop target position due to reasons such as a stopped vehicle ahead or a read traffic signal ahead, the driver releases the accelerator pedal before the stop target position by a predetermined distance and coasts to a stop.

### Citation List

### Patent Literature

PTL 1

Japanese Patent Application Laid-Open No. 2020-152279

### SUMMARY OF INVENTION

### Technical Problem

In the case of coasting to stop at the stop target position while driving uphill, when the driver releases the accelerator pedal at a predetermined distance before the stop target position, using the same sense as when driving on a flat road, the deceleration (negative acceleration) is greater on the uphill road than on the flat road, and thus the vehicle stops short of the stop target position. Thus, the driver needs to frequently operate the accelerator pedal on the uphill road, such as returning the foot released from the accelerator pedal to the accelerator pedal to step on the accelerator pedal to accelerate by the drive device such that the vehicle stops at the stop target position.

An object of the present disclosure is to provide a vehicle control device for stopping the vehicle at a position where the vehicle should stop without the driver frequently operating an accelerator pedal on an uphill road.

### Solution to Problem

A vehicle control device according to the present disclosure is a vehicle control device that controls a drive device of a vehicle based on an operation amount of an operation member, and the vehicle control device includes: an operation amount acquisition section that acquires the operation amount; a gradient acquisition section that acquires a gradient of a road surface on which the vehicle is traveling; and a control section that controls the drive device such that the vehicle stops at a reference stopping distance, in a case where the gradient is uphill and the operation amount becomes zero during traveling by the drive device.

Furthermore, a vehicle control device according to the present disclosure is a vehicle control device that controls a drive device of a vehicle based on an operation amount of an operation member, and the vehicle control device includes: an operation amount acquisition section that acquires the operation amount; a gradient acquisition section that acquires a gradient of a road surface on which the vehicle is traveling; a surrounding situation acquisition section that acquires a surrounding situation of the vehicle; a necessary stopping distance calculation section that calculates a necessary stopping distance based on the surrounding situation; and a control section that controls the drive device such that the vehicle stops at the necessary stopping distance, in a case where the gradient is uphill and the operation amount becomes zero during traveling by the drive device.

### Advantageous Effects of Invention

According to the vehicle control device according to the present disclosure, the vehicle reliably stops at a position where the vehicle should stop even while traveling an uphill road, such that the driver does not need to frequently operate the accelerator pedal.

### BRIEF DESCRIPTION OF DRAWINGS

FIG. 1 is a diagram illustrating a configuration of a vehicle;

FIG. 2 is a functional block diagram of a vehicle control device;

FIG. 3 is a flowchart of an operation of the vehicle control device;

FIG. 4A illustrates a graph showing an example of a time variation in the output of a drive device; and

FIG. 4B illustrates a graph showing an example of a time variation in the vehicle speed.

### DESCRIPTION OF EMBODIMENTS

Hereinafter, an embodiment of the present disclosure will be described with reference to the drawings. It should be noted that the embodiment described below is a specific example of the present disclosure. Therefore, each component, the arrangement position of each component, a connection form, and the like shown in the following embodiment are merely examples, and do not limit the spirit of the present disclosure. In addition, components that are not recited in the independent claims among the components in the following embodiment will be described as optional components.

Furthermore, each drawing is a schematic diagram, and is not necessarily exactly illustrated. In each drawing, substantially the same configurations are denoted by the same reference numerals, and redundant descriptions may be omitted or simplified.

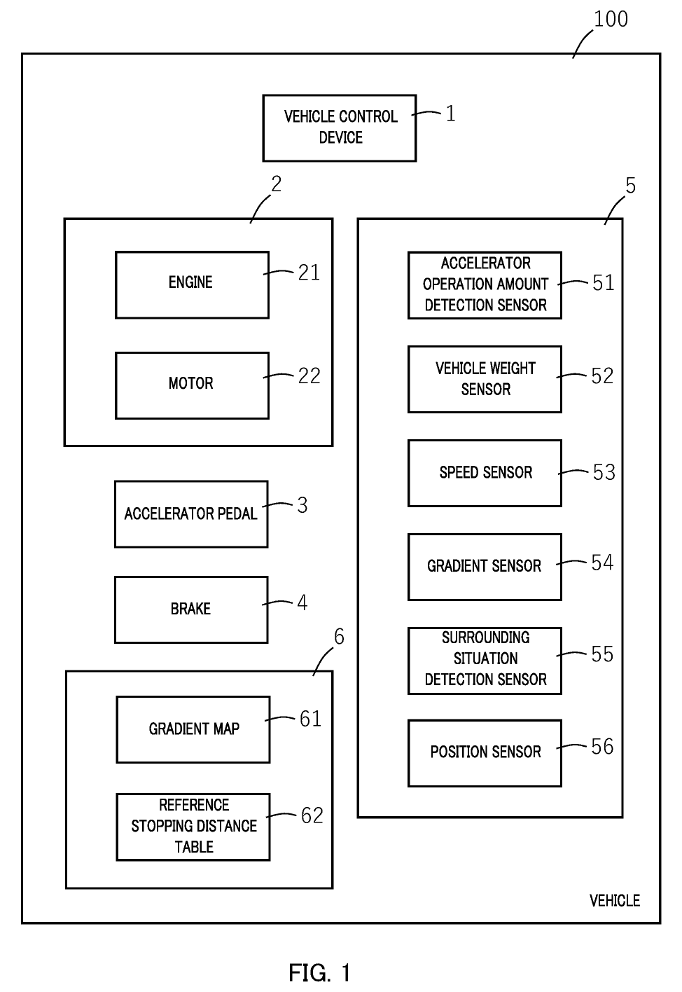

FIG. 1 is a diagram illustrating a configuration of a vehicle including a vehicle control device of the present disclosure. Vehicle 100 includes: drive device 2 that drives vehicle 100; accelerator pedal 3 for a driver to operate drive device 2; brake 4; detection device 5 including various sensors; storage device 6; and vehicle control device 1 that controls drive device 2 and brake 4.

Vehicle control device 1 is a computer with a general configuration that includes a processor, a memory, a communication device, a user interface, and the like.

Drive device 2 is, for example, a hybrid drive device including engine 21 and motor 22, but may include only engine 21 or motor 22.

Accelerator pedal 3 is a general accelerator pedal operated by the driver with a foot, and corresponds to an operation member of the present disclosure. Fuel is supplied to engine 21 or electric power is supplied to motor 22 according to a depression amount of accelerator pedal 3, and a driving force of drive device 2 is transmitted to wheels (not shown). In addition, when the foot is released from accelerator pedal 3, the supply of fuel or electric power is stopped, and the driving force of drive device 2 becomes zero.

Brake 4 is a general brake device that decelerates vehicle 100, and is a disk brake, a regenerative brake, or the like. Brake 4 exerts a braking force according to a depression amount of a brake pedal (not shown). In addition, brake 4 is operated by the control of vehicle control device 1 to exert the braking force.

Detection device 5 includes: accelerator operation amount detection sensor 51 that detects an operation amount of accelerator pedal 3; vehicle weight sensor 52 that detects a weight of vehicle 100; speed sensor 53 that detects a speed of vehicle 100; gradient sensor 54 that detects a gradient of a road surface on which vehicle 100 is traveling; surrounding situation detection sensor 55 that detects a surrounding situation of vehicle 100; position sensor 56 that detects a position of vehicle 100, such as a GPS, and the like. Surrounding situation detection sensor 55 is, for example, an obstacle sensor such as an ultrasonic sensor or a radar that detects an obstacle in front, or an imaging device that detects a traffic light, a sign, or the like in front.

Storage device 6 is a general memory device or the like, and stores information such as gradient map 61 such as a road map having information on an elevation, and reference stopping distance table 62, which is a table showing distances, classified by vehicle weight and speed, until the vehicle stops by coasting on a flat road. For gradient map 61, the gradient of the road surface during traveling can be acquired when the current position and the traveling direction of vehicle 100 are known. Reference stopping distance table 62 is created, for example, by measuring the reference stopping distance for each vehicle weight and speed in advance by an experiment or the like. The coasting herein means a state in which the vehicle travels by inertia by the driver releasing the foot from the accelerator pedal during traveling of the vehicle, and includes a case of traveling in a state in which the clutch is connected or disconnected for an engine-driven vehicle, and includes a case of traveling in a state in which the clutch is connected or disconnected or a case in which the regenerative brake is operated or not operated for an electric vehicle.

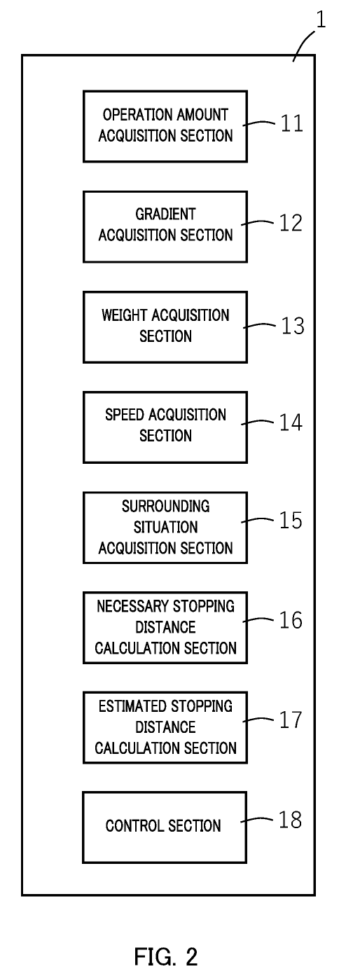

FIG. 2 is a functional block diagram of vehicle control device 1. Each functional unit having a name of “XX-section” corresponds to a function exhibited by the processor of vehicle control device 1 executing the control program. Operation amount acquisition section 11 acquires the operation amount of accelerator pedal 3 from accelerator operation amount detection sensor 51. The operation amount is, for example, information on a rotational angle or a moving distance of accelerator pedal 3.

Gradient acquisition section 12 acquires the gradient of the road surface on which vehicle 100 is traveling, from gradient sensor 54 or gradient map 61. The gradient is, for example, information on an inclination angle of the road surface.

Weight acquisition section 13 acquires the total weight of vehicle 100 from vehicle weight sensor 52. The total weight may be acquired before the start of traveling or during the traveling.

Speed acquisition section 14 acquires the traveling speed of vehicle 100 from speed sensor 53. The traveling speed is measured in, for example, kilometers per hour or meters per second.

Surrounding situation acquisition section 15 acquires the surrounding situation of vehicle 100 from surrounding situation detection sensor 55. The surrounding situation of vehicle 100 refers to a situation that may be related to the stop of vehicle 100, such as the presence or absence of a stopped vehicle in front of vehicle 100, the presence or absence of a pedestrian in front of vehicle 100, a traffic light and the color in front of vehicle 100, a content of a sign such as a stop in front of vehicle 100, and the presence or absence of a crosswalk and a person crossing in front of vehicle 100.

Necessary stopping distance calculation section 16 calculates a distance to a position at which vehicle 100 is to stop, based on the surrounding situation acquired by surrounding situation acquisition section 15. The necessary stopping distance is, for example, a distance to a predetermined position in front of an obstacle such as a stopped vehicle or a pedestrian in the case where an obstacle is present in front of the vehicle, a distance to a stop line in front of a red traffic light in the case where a red traffic light is present, or a distance to a position in front of a crosswalk in the case where a crosswalk with a crossing pedestrian is present. That is, the necessary stopping distance is a distance to a position at which the vehicle is to stop.

Estimated stopping distance calculation section 17 calculates an estimated stopping distance until vehicle 100 advances and stops by coasting on an uphill road. The estimated stopping distance can be calculated mechanically from vehicle weight, speed, frictional force, and air resistance. Here, the frictional force and the air resistance can be obtained in advance by, for example, an experiment.

Control section 18 controls, based on acquired information, drive device 2 and brake 4 such that vehicle 100 advances by the reference stopping distance or the necessary stopping distance and stops.

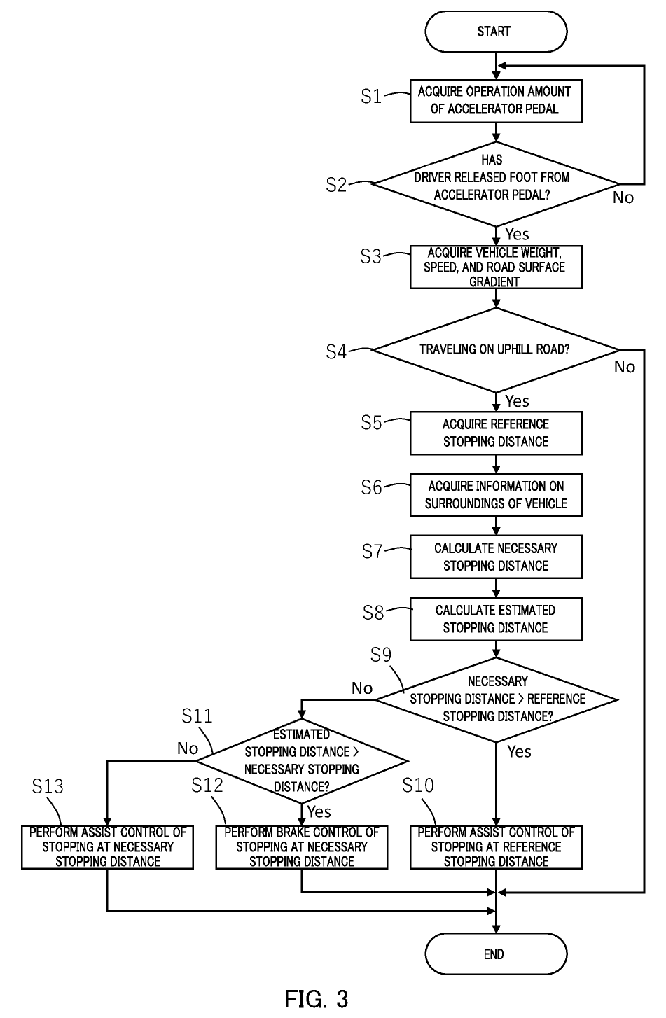

Next, an operation of a processor of vehicle control device 1 according to the present disclosure (hereinafter, sometimes simply referred to as “vehicle control device”) will be described with reference to a flowchart in FIG. 3. Vehicle control device 1 acquires the operation amount of accelerator pedal 3 from accelerator operation amount detection sensor 51 (step S1). Next, vehicle control device 1 determines whether the driver has released the foot from accelerator pedal 3, based on the operation amount of accelerator pedal 3 (step S2). Specifically, vehicle control device 1 determines that the driver has released the foot from accelerator pedal 3 when the operation amount of accelerator pedal 3 is changed from a positive value to zero. In a case where it cannot be determined that the driver has released the foot from accelerator pedal 3 (step S2: No), acquisition of the operation amount of accelerator pedal 3 is repeated.

When the driver has released the foot from accelerator pedal 3 (step S2: Yes), vehicle control device 1 acquires the vehicle weight, the speed, and the road surface gradient from vehicle weight sensor 52, speed sensor 53, and gradient sensor 54, respectively (step S3). The road surface gradient may be acquired from gradient map 61 instead of being acquired from gradient sensor 54.

Then, vehicle control device 1 determines whether vehicle 100 is traveling on an uphill road, based on the acquired road surface gradient (step S4). Specifically, vehicle control device 1 determines that vehicle 100 is traveling on an uphill road when the road surface gradient is a positive value. When the vehicle is not traveling on an uphill road (step S4: No), the process ends.

When vehicle 100 is traveling on an uphill road (step S4: Yes), based on the current vehicle weight and speed, a stopping distance at the corresponding vehicle weight and speed is acquired from reference stopping distance table 62 stored in storage device 6 as a reference stopping distance (step S5). In a case where there is no information on the stopping distance for the vehicle weight and speed that correspond to the current condition, the stopping distance for a similar vehicle weight and speed may be acquired.

Next, vehicle control device 1 acquires information on the surroundings of vehicle 100 from surrounding situation detection sensor 55 (step S6). Then, the necessary stopping distance, which is a distance at which vehicle 100 needs to stop, is calculated based on the information on the surroundings of vehicle 100 (step S7). Next, vehicle control device 1 calculates the estimated stopping distance (step S8).

Subsequently, vehicle control device 1 determines whether the necessary stopping distance is longer than the reference stopping distance (step S9). In a case where the necessary stopping distance is longer than the reference stopping distance (step S9: Yes), vehicle control device 1 performs assist control of drive device 2 such that vehicle 100 advances by the reference stopping distance and then stops (step S10). The assist control is to control drive device 2 such that the vehicle does not stop before advancing by the reference stopping distance on the uphill road, and to assist the traveling such that the vehicle travels by the reference stopping distance and then stops. The required amount of assist can be calculated as an output for causing the vehicle to advance, by the difference between the reference stopping distance and the estimated stopping distance, from the estimated stopping distance and to stop. In performing the assist control, vehicle control device 1 may drive any of engine 21 or motor 22, but it is preferred to drive motor 22 from the viewpoint of fuel economy and reduction of exhaust gas.

On the other hand, in a case where the necessary stopping distance is equal to or shorter than the reference stopping distance (step S9: No), vehicle control device 1 determines whether the necessary stopping distance is shorter than the estimated stopping distance (step S11). In a case where the necessary stopping distance is shorter than the estimated stopping distance (step S11: Yes), vehicle control device 1 performs brake control of brake 4 such that vehicle 100 advances by the necessary stopping distance and then stops (step S12). The brake control is to control brake 4 such that the vehicle advances by the necessary stopping distance and then stops on the uphill road. The required braking force can be calculated as a braking force for stopping the vehicle at a distance shorter than the estimated stopping distance by the difference between the estimated stopping distance and the necessary stopping distance.

In a case where the necessary stopping distance is equal to or longer than the estimated stopping distance (step S11: No), vehicle control device 1 performs assist control such that vehicle 100 advances by the necessary stopping distance and then stops (step S13). The assist control is to control drive device 2 such that vehicle 100 does not stop before advancing by the necessary stopping distance on the uphill road, and to assist the traveling such that vehicle 100 advances by the necessary stopping distance and then stops. The required amount of assist can be calculated as an output for causing the vehicle to advance, by the difference between the necessary stopping distance and the estimated stopping distance, from the estimated stopping distance and to stop.

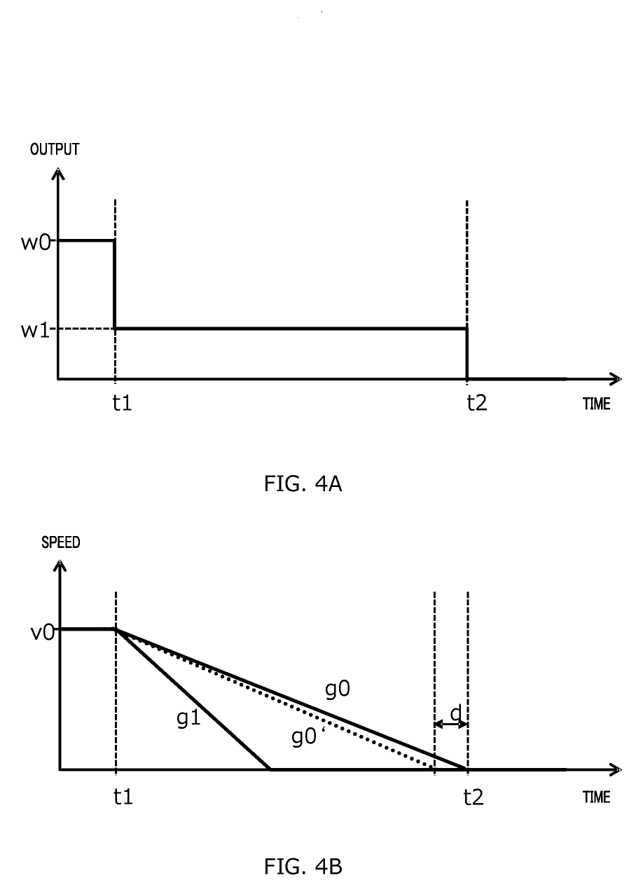

FIG. 4A and FIG. 4B are an example of graph showing a time variation of the output of drive device 2 (FIG. 4A) and a time variation of the speed (FIG. 4B) in a case where vehicle control device 1 according to the present disclosure operates and vehicle 100 advances by the reference stopping distance by coasting on the uphill road and then stops. In FIG. 4A, vehicle 100 travels with a predetermined output w0 of drive device 2 until t1. When the driver releases the foot from accelerator pedal 3 at t1, the output of drive device 2 decreases, but the vehicle is driven with an output w1 less than w0 in order to perform the assist control. When vehicle 100 advances by the reference stopping distance and then stops at t2, the output of drive device 2 becomes zero.

On the other hand, in FIG. 4B, vehicle 100 travels at a predetermined speed v0 until t1. When the driver releases the foot from accelerator pedal 3 at t1, the speed decreases in the same manner as in the case where the vehicle coasts on the flat road (graph g0). Then, the speed of vehicle 100 becomes zero at t2, and the vehicle stops. In this case, as indicated by a dotted line g0', the vehicle may stop before t2 as long as the error is the predetermined error d or less. That is, the vehicle may stop before the necessary stopping distance. Graph g1 shows a state in a case where vehicle control device 1 does not perform the assist control and the vehicle coasts to decelerate and then advances by the estimated stopping distance and then stops.

As described above, when the driver releases the foot from accelerator pedal 3 while the vehicle is traveling an uphill road, vehicle 100 advances by the reference stopping distance and then stops. Therefore, the driver can release the foot from accelerator pedal 3 at a predetermined distance before the target stopping position with the same sense as when driving on a flat road, and does not need to perform a complicated operation of releasing the foot from accelerator pedal 3 and then stepping on accelerator pedal 3 again. Further, in a case where the necessary stopping distance is shorter than the reference stopping distance, drive device 2 or brake 4 is controlled to cause the vehicle to reliably advance by the necessary stopping distance and then stop. Thus, the driver can safely stop the vehicle by only releasing the foot from accelerator pedal 3.

In the above-described embodiment, the vehicle is controlled to stop at the reference stopping distance in a case where the necessary stopping distance is longer than the reference stopping distance. However, the vehicle may be controlled to advance by the necessary stopping distance and then stop, regardless of the reference stopping distance or the necessary stopping distance is long or short. That is, when the driver releases the foot from accelerator pedal 3 on the uphill road, brake control may be performed such that the vehicle stops at the necessary stopping distance in a case where the necessary stopping distance is shorter than the estimated stopping distance, and assist control may be performed such that the vehicle stops at the necessary stopping distance in a case where the necessary stopping distance is equal to or longer than the estimated stopping distance. Accordingly, the vehicle appropriately advances by the necessary stopping distance and then stops, regardless of the timing at which the driver releases the foot from the accelerator pedal.

In addition, in the above-described embodiment, the vehicle has been described as advancing by the reference stopping distance or the necessary stopping distance and then stopping. However, for example, the control by vehicle control device 1 may be stopped when the vehicle speed is equal to or lower than a predetermined speed or when the driver operates the brake pedal. Accordingly, the driver can stop the vehicle with less discomfort.

Furthermore, in the above-described embodiment, the output of drive device 2 during the assist control is constant at w1. However, the output of drive device 2 during the assist control need not be constant. That is, the output does not need to be constant as long as vehicle 100 can advance by the reference stopping distance or the necessary stopping distance and then stop. For example, the output may be gradually decreased according to the remaining distance to the reference stopping distance or the necessary stopping distance. This allows the output of the drive device to decrease as the vehicle speed decreases, whereby the driver can stop the vehicle with less discomfort.

### INDUSTRIAL APPLICABILITY

It is possible to provide a vehicle that stops by coasting on uphill roads in a manner that feels natural to the driver.

1. A vehicle control device that controls a drive device of a vehicle based on an operation amount of an operation member, the vehicle control device comprising:
an operation amount acquisition section that acquires the operation amount;
a gradient acquisition section that acquires a gradient of a road surface on which the vehicle is traveling; and
a control section that controls the drive device such that the vehicle stops at a reference stopping distance, in a case where the gradient is uphill and the operation amount becomes zero during traveling by the drive device.

2. The vehicle control device according to claim 1, further comprising:
a weight acquisition section that acquires a total weight of the vehicle; and
a speed acquisition section that acquires a speed of the vehicle, wherein
the control section controls the drive device based on the total weight and the speed.

3. The vehicle control device according to claim 1, further comprising:
a surrounding situation acquisition section that acquires a surrounding situation of the vehicle; and
a necessary stopping distance calculation section that calculates a necessary stopping distance based on the surrounding situation, wherein
the control section controls the drive device such that the vehicle stops at the necessary stopping distance, in a case where the necessary stopping distance is shorter than the reference stopping distance.

4. The vehicle control device according to claim 3, further comprising an estimated stopping distance calculation section that calculates an estimated stopping distance, wherein
the control section controls a brake device instead of controlling the drive device, in a case where the necessary stopping distance is shorter than the estimated stopping distance.

5. A vehicle control device that controls a drive device of a vehicle based on an operation amount of an operation member, the vehicle control device comprising:
an operation amount acquisition section that acquires the operation amount;
a gradient acquisition section that acquires a gradient of a road surface on which the vehicle is traveling;
a surrounding situation acquisition section that acquires a surrounding situation of the vehicle;
a necessary stopping distance calculation section that calculates a necessary stopping distance based on the surrounding situation; and
a control section that controls the drive device such that the vehicle stops at the necessary stopping distance, in a case where the gradient is uphill and the operation amount becomes zero during traveling by the drive device.

6. The vehicle control device according to claim 5, further comprising an estimated stopping distance calculation section that calculates an estimated stopping distance, wherein
the control section controls a brake device instead of controlling the drive device, in a case where the necessary stopping distance is shorter than the estimated stopping distance.
